(19) United States
(12) Patent Application Publication
(10) Pub. No.: US 2010/0299905 A1
(43) Pub. Date: Dec. 2, 2010

(54) Fast draw security holster

(75) Inventors: Jason Lee McCoy, San Diego, CA (US); George Thomas Straza, San Diego, CA (US)

Correspondence Address: JASON LEE MCCOY, SUITE A, 10051 OLD GROVE RD, SAN DIEGO, CA, 92131, US

(73) Assignee: Jason Lee McCoy, San Diego, CA (US)

(21) Appl. No.: 12/800,852

(22) Filed: May 24, 2010

Related U.S. Application Data
(60) Provisional application No. 61/217,040, filed on May 27, 2009.

(51) Int. Cl. B23P 17/04

(52) U.S. Cl. 29/428

(57) ABSTRACT

A holster for a handgun having an open “U” shape body and or having one or multiple spring loaded self-closing doors/flaps connected to the holster body by pivots, thereby defining a cavity for receiving and holding a handgun, allowing the handgun to be drawn in multiple directions, a thumb/finger enagaging lever with a connecting nib member that extends through the trigger guard of the handgun and has a pivot connection to the holster body for securing a handgun within the cavity/pocket of the holster, a finger enagaging cover guard encloses the finger engaging lever/button, obstructing unauthorized observation of the action of operating the finger engaging lever/button.

### BACKGROUND OF THE INVENTION

The present invention is directed generally to a holster for a weapon such as a pistol/handgun. More specifically, the present invention is directed to a holster with an open “U” shape holster body and/or having one or multiple spring loaded self-closing flaps/doors connected to the front and/or rear of the holster where it would be mounted to the user allowing the handgun to be easily removed from the holster in a forward, backward, upward or downward direction. The holster of the present invention has a rotating guard retention system for securing a handgun such that the handgun is restrained in the holster by means of a nib member going through the trigger guard of the handgun and a finger engaging guard which prevents unauthorized observation of the finger engaging lever being engaged.

### DESCRIPTION OF RELATED ART

Various devices have been employed to secure the gun in the holster and prevent unauthorized access, such as cover flaps, restraining straps, spring mechanisms, and custom molded holsters. While these devices have generally been effective in discouraging unauthorized access to officer's and military personnel handguns, they become obstacles which the military and law enforcement will have to overcome such as unlocking the handgun multiple times and pulling up on the handgun to withdraw. A telegraphing motion takes place, while drawing of the firearm by means of having the user of the holster unlock handgun from the holster and to pull the handgun up or out from the holster to perform a draw.

Some holsters rely on a friction fit between the gun and the holster to secure the handgun in place. Other holsters rely on guards that hold the handgun in place, while most holsters rely on an upward motion to withdraw the handgun from the holster. These types of holsters are generally not suitable for situations where the handgun is subject to a great deal of movement because such movement could cause the handgun to lose friction engagement with the holster and allow the handgun to become dislodged from the holster.

Generally, with holster designs that rely on straps, flaps and guard arrangements to retain the handgun in the holster, the user must first unfasten and/or rotate the strap or unfasten and open a flap or guard and second pull up before the handgun can be withdrawn.

At least five other designs provide alternative methods for restraining a handgun in a holster: Serpa, U.S. Pat. No. 5,918,784 issued Jul. 6, 1999 and Kincaid, Publication No. US2009/0321480A1 filled date Jun. 30, 2008. The Serpa and Kincaid designs provide a rigid holster having retention devices that engages the trigger guard of a handgun in order to retain a handgun in the holster. These designs, however, create some disadvantages.

First among these disadvantages is the Serpa holster, which only has the option of drawing the gun in an upward motion while removing the handgun from the holster. Second, the Kincaid holster includes a number of retention devices that hold the handgun in place but require of a number of steps to unlock the handgun from the holster and withdraw the handgun in a upward or outward direction thus increasing the time required to withdrawal the handgun from the holster and aim at the target.

Third, handgun users must be able to quickly and easily remove the handgun from its holster regardless of the type of holster used or the location of the holster. Additionally, users need to be assured that, when not in use, the handgun will remain safely in the holster. Of greater importance, the user must be able to quickly secure or draw the weapon at a moment's notice.

These holsters mentioned above all require the user of the handgun to pull up or pull out in an upward motion to withdraw the handgun from the holster. These methods are often not preferred because of the time that is required to pull the handgun up or out from the holster versus drawing the handgun in a forward motion.

Designs providing a front draw holster include Shoemaker, U.S. Pat. No. 5,018,653 issued May 28, 1991, Bianchi, U.S. Pat. No. 4,277,007 issued Jul. 7, 1981 and Villwock, U.S. Pat. No. 3,008,617 issued Nov. 14, 1961. The Shoemaker design provides a front draw holster having a “U” shape holster body and a restraining strap, which goes over the handgun to restrain the handgun. The Bianchi holster design provides a holster with an open “U” shape body having a retention strap with nib member, which restrains the handgun in the holster. The Villwock design provides a front draw holster by mean of using magnetic snap fasteners on the front doors to hold the handgun in the holster. These designs, however, create some disadvantages.

One of the disadvantages of the Shoemaker design would be that the user would have to move the strap, flap or guard before the handgun can be re-holstered, typically causing the user to look down at the holster and take his or her eyes off of a possible target. Then, once the handgun has been re-holstered, the user must physically reposition and refasten the strap, flap or guard before the handgun is securely retained within the holster.

Disadvantages of the Bianchi design would be that the user would have to look down at the holster, taking the eyes off the target to remove the retention strap to withdraw the handgun from the holster. Then, once the handgun is to be re-holstered, the user must physically remove the retention strap in order to lock the handgun in the holster.

Disadvantages of the Villwock design would be the front door having snap fasteners that would interfere with the drawing of the handgun due to the snap fasteners getting caught on the edges of a handgun. Also, the Villwock holster design does not include a retention device to secure the handgun to the holster, preventing unauthorized access. Then, once the handgun is to be re-holstered, the user must physically close front doors and snap the fasteners into their sockets in order to enclose the handgun in the holster.

### BRIEF SUMMARY OF THE INVENTION

It is the object and advantage of the present invention to provide a handgun holster with a open “U” shape body having one or multiple spring loaded self-closing doors/flaps, which are designed to allow the handgun to be enclosed in the holster pocket and to be released forward or in multiple directions from the user/holster and closed after drawing the holstered firearm. The holster of the present invention offers the user the ability to unlock the handgun and to draw the handgun in a forward, backwards, downwards or upward direction. This is made possible by having one or multiple spring loaded self-closing doors/flaps mounted or fixed to the front/rear of the handgun/holster, eliminating the requirement of pulling up/out motion, as found in most prior art.

It is the object and advantage of the present invention to provide a handgun holster that allows the user to not only to pull up or pull out the handgun from the holster but also to allow the handgun to be drawn in multiple directions wherein the holster would have an open “U” shape holster body where the front or rear of the handgun is exposed, or have one or multiple spring loaded self-closing door/flap connected to the front or rear of the holster to form a pocket/cavity to enclose the handgun in the holster.

It is the object and advantage of the present invention to provide a handgun holster with a thumb engaging lever/button located on the inner side wall between the user and the holster which is engaged by the users thumb to release the handgun so it can be withdrawn in multiple directions away from the holster and/or have a finger engaging lever/button located on the outer side of the holster, where it can be engaged by the user's finger to release the handgun so it can be withdrawn in multiple directions away from the holster, where it would be mounted to a duty belt, ankle holster, leg/thigh holster, and chest, shoulder/armpit holster. The holster of the present invention also may include a finger engaging guard, which prevents unauthorized observation of and access to the finger engaging lever when it is being engaged.

### BRIEF DESCRIPTION OF THE DRAWINGS

The illustrative embodiments of this invention will be described in detail, with reference to the following figures, wherein like reference numerals refer to like parts throughout the several views, and wherein:

FIG. 1A shows an outer side view of an illustrative embodiment of the holster wherein a handgun is enclosed in a cavity/pocket of the holster.

FIG. 1B shows an outer view of illustrative embodiments of the holster being drawn in a forward motion away from the holster with a spring-loaded self-closing door/flap in the open position.

FIG. 1C shows an inner view of the first illustrative embodiment of the holster wherein the handgun is being drawn in a forward motion away from the holster.

FIG. 1D shows an inner view of the illustrative embodiments of the holster wherein the handgun is inserted into the holster cavity or pocket and the spring-loaded self-closing door/flap are in the closed position.

FIG. 2A shows a front view of the first illustrative embodiment of the holster with the thumb engaging lever and multiple spring-loaded self-closing doors/flaps connected to the front.

FIG. 2B shows a rear view of the illustrative embodiments of the holster with a thumb engaging lever located on the inner side of the holster.

FIG. 3A shows an inner view of the illustrative embodiments of the holster with a thumb engaging lever and the spring-loaded self-closing door/flap in the closed position.

FIG. 3B shows an inner view of an illustrative embodiment of the shoulder/armpit holster wherein the handgun is being drawn in a downward direction.

FIG. 3C shows an outer side view of an illustrative embodiment of the holster wherein the handgun is inserted into the shoulder/armpit holster with the spring-loaded door/flap in the closed position.

FIG. 3D shows an outer side view, of an illustrative embodiment of the shoulder/armpit holster wherein the handgun is being drawn in a downward motion.

FIG. 4A shows a front view of an illustrative embodiment of the shoulder/armpit holster.

FIG. 4B shows a rear view of an illustrative embodiment of the shoulder/armpit holster.

FIG. 5A shows the outer side view of the illustrative embodiments of the holster with a finger engaging lever and spring-loaded self-closing door/flap in the closed position.

FIG. 5B shows the outer side view of an illustrative embodiment of the holster wherein a handgun is inserted into the holster with a finger engaging lever guard and a spring-loaded self-closing door/flap in the closed position.

FIG. 6A shows a front view of an illustrative embodiment of the holster with a finger engaging lever with a connecting nib member which goes through the trigger guard area, and a finger engaging guard adjacent to the finger engaging lever or button with multiple spring loaded self-closing doors/flaps.

FIG. 6B shows a rear view of an illustrative embodiment of the holster with rear view of the finger engaging lever guard.

FIG. 7 shows an inner view of the illustrative embodiments of the holster with a handgun inserted into the holster with a thumb engaging lever with a spring-loaded self-closing door/flap in the closed position.

FIG. 8A shows a top view of an illustrative embodiment of the holster with one spring-loaded self-closing door/flap in the closed position and a thumb engaging lever on the inner side of the holster.

FIG. 8B shows a top view of an illustrative embodiment of the holster with one spring loaded self-closing door/flap with a finger engaging lever and a finger engaging lever guard illustrated in dashed lines.

FIG. 9A shows a top view of an illustrative embodiment of the holster with two spring-loaded self-closing door/flap in the closed position and a thumb engaging lever on the inner side of the holster.

FIG. 9B shows a top view of the illustrative embodiments of the holster with one spring-loaded self-closing door/flap in the closed position and a finger engaging lever on the inner side of the holster and a finger engaging lever guard illustrated in dashed lines.

FIG. 10A shows a top view of an illustrative embodiment of the holster with an open “U” shape body with a thumb engaging lever or button on the inner side of the holster.

FIG. 10B shows a top view of an illustrative embodiment of the holster with an open “U” shape body, with a finger engaging lever or button located on the outer side of the holster along with the finger engaging lever guard illustrated in dashed lines.

FIG. 11A shows the thumb engaging lever.

FIG. 11B shows the finger engaging lever.

### DETAILED DESCRIPTION OF THE INVENTION

For simplicity and clarity, the design factors and operating principles of the fast draw security holster 100 are explained with reference to various illustrated embodiments of a fast draw holster 100, according to this invention. The basic explanation of the design factors and operating principles of the fast draw security holster 100, is applicable for the understanding, design, and operation of the fast draw security holster of this invention.

Furthermore, it should be appreciated that, for simplicity and clarity, the embodiments of this invention will be described with reference to a semiautomatic-type handgun 2F, being secured within the present fast draw security holster 100. However, it should be appreciated that the operating principles of the fast draw security holster 100 of this invention may also be employed to construct holsters or holders for any revolver 2F, semiautomatic-type handgun 2F, edged weapon, less than lethal product (i.e., a taser, pepper spray, mace canister, baton, or the like), or other device, so long as these items have an appropriate edge, surface, or void that may be engaged.

Furthermore, it is also within the scope of the present invention that the fast draw security holster 100 may be employed as a holder for tactical accessories, such as ammunition magazines and/or flashlights, as well as for everyday items such as cell phones, personal digital assistants, or the like.

It should also be appreciated that the terms “handgun 2F”, “handgun holster 100”, “fast draw security holster 100” and “weapon 2F” are used for basic explanation and understanding of the operation of the systems, methods, and apparatuses of this invention. Therefore, the terms “gun”, “handgun”, “handgun holster”, “fast draw security holster” and “weapon” are not to be construed as limiting the systems, methods, apparatuses, or applications of this invention.

The holster 100, of the present invention, having a body formed by an inner side wall 2J, an outer side wall 2K, and a rear wall 2M, to form a open “U” shape holster 100, body or have one or multiple torsion spring-loaded 2E, self-closing doors/flaps 2D, joined together by a pin/rod 2E1, connected to the front of the holster 100, to form a cavity/pocket 2H. The finger grove 2A and a finger guide 2B are formed in the outer side wall 2K, where the finger engaging lever/button 2C, is mounted to the outer side wall 2K of the Holster 100. The finger engaging retention lever/button 2C is formed with a spring groove 2C4, and is mounted to the outer side wall 2K, of the holster 100 body by means of a pin/rod 2C5, in conjunction with a torsion spring 2C3, to be functional by means of pivoting or rotating. The holster 100 has formed screw receiving holes 2L, to allow a belt/strap receiving back/hip plate 2P, with belt/strap receiving slots 2O, to be mounted to the inner side wall 2J.

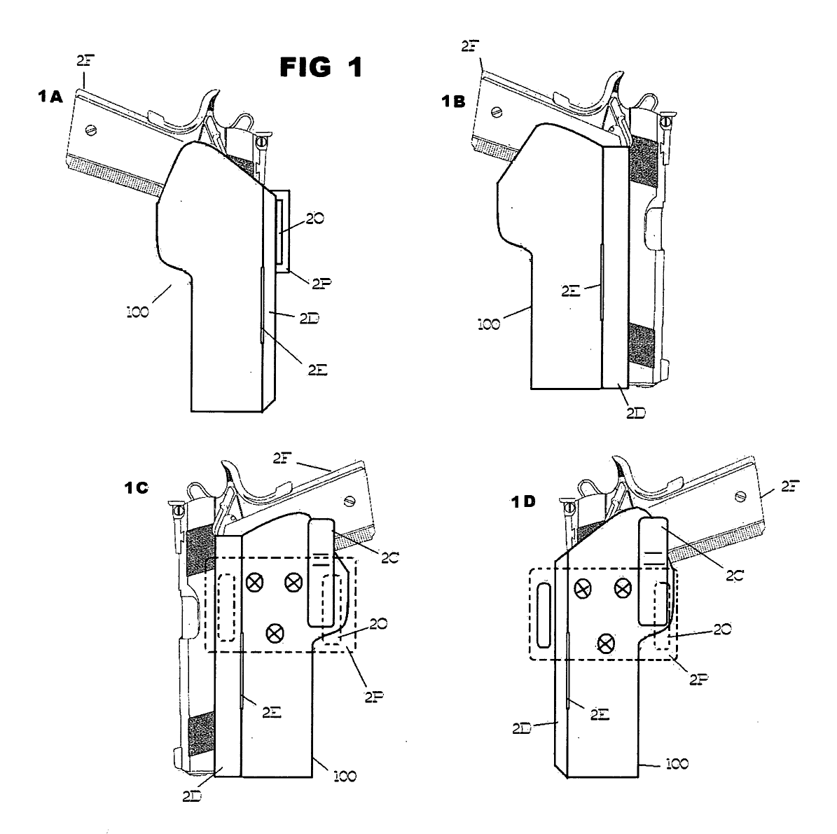

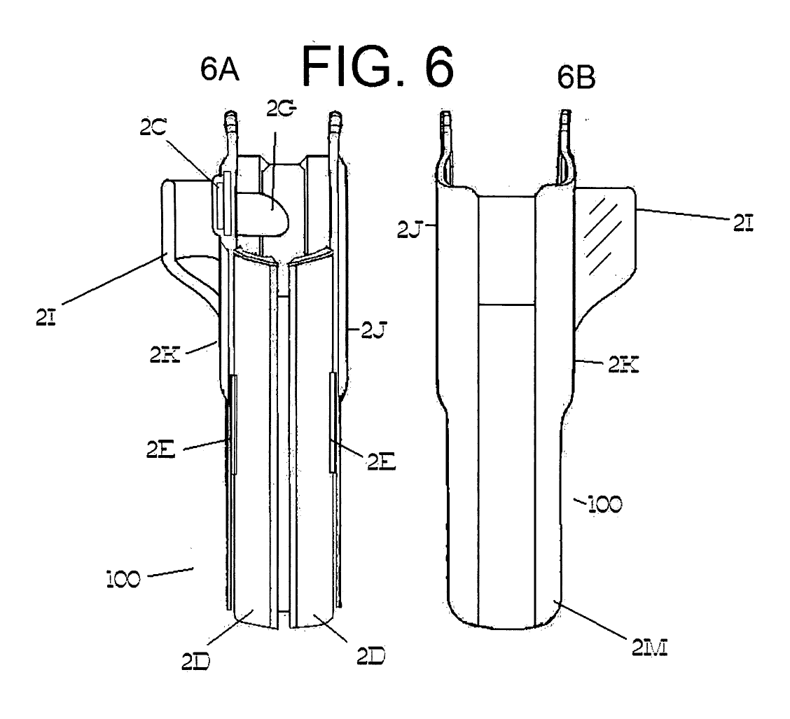

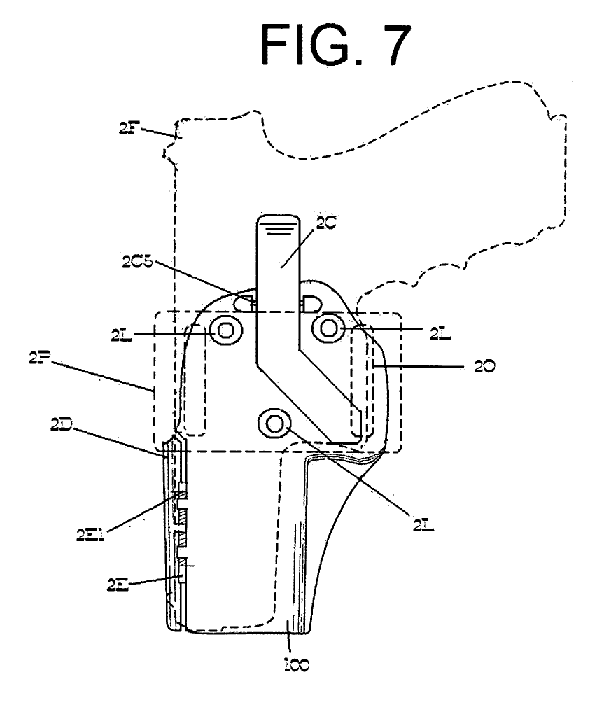

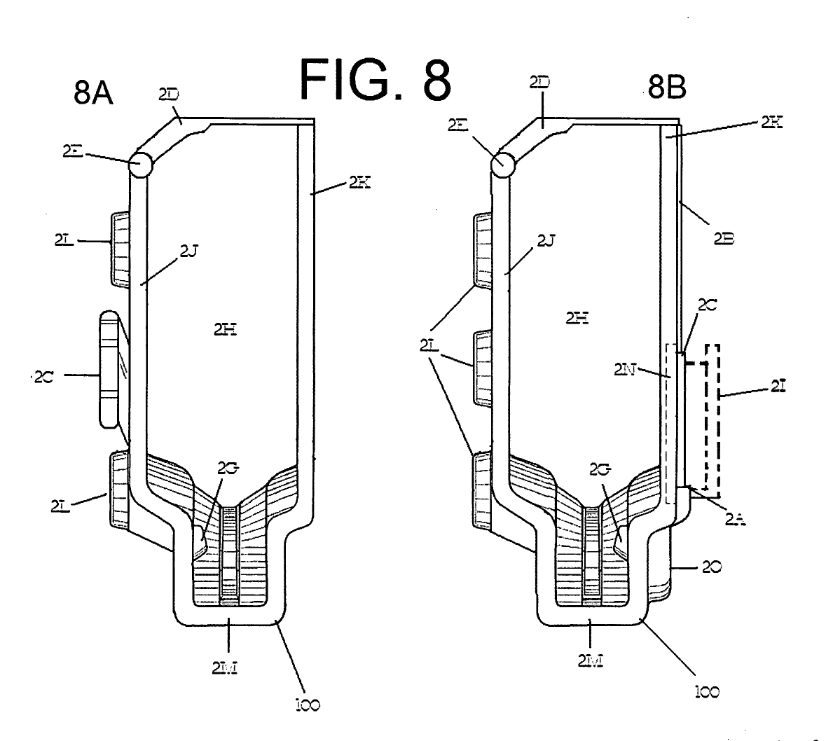

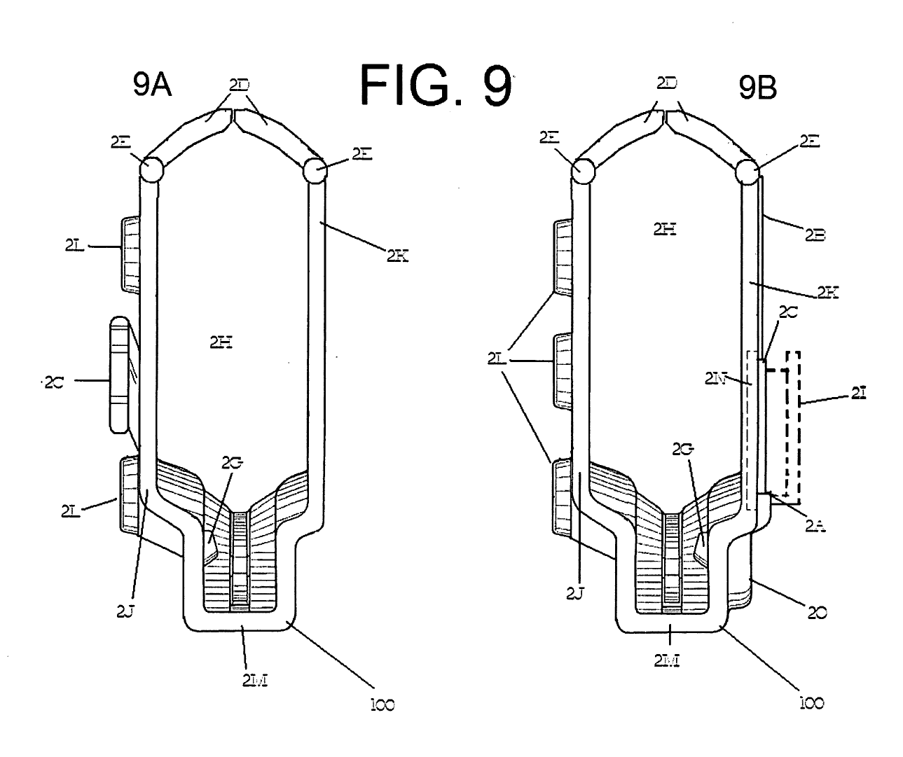

FIGS. 1-10B, show various views of a first, illustrative, non-limiting embodiment of a fast draw security holster 100, having a retention device/system 2C, and an open “U” shape and/or having one or multiple spring loaded self-closing doors/flaps 2D, mounted to the front and/or rear 2M, of the handgun 2F, according to this invention. It should be appreciated that, in various exemplary embodiments, the fast draw security holster 100 is adapted to retain a semiautomatic-type handgun 2F, as illustrated in FIGS. 1, 3, 5 and 7. Generally, semiautomatic type handguns 2F, include a slide, a frame, and a hammer and/or firing mechanism and have a front, or muzzle, end and a back, or hammer/firing pin, end. The slide generally includes a barrel, while the frame generally includes a grip, a trigger guard, and a trigger. The trigger guard includes an inner surface, which defines an area wherein the trigger is located and allows a user's finger access to the trigger, and an outer surface, which defines the outer perimeter of the trigger guard.

As illustrated in FIGS. 1-10B, the fast draw security holster includes a holster body defining a cavity for receiving and holding the handgun. The cavity 2H may be formed from any number or combination of walls, including, for example, a “U” shape wall with an open front portion and/or one or multiple spring-loaded self-closing doors/flaps 2D, mounted to the front or rear 2M, of the handgun 2F. Alternatively, the cavity 2H may be formed by a material shaped or bent substantially in a “U” shape. Thus, the cavity may be formed by any cavity 2H, space, or platform that is capable of retaining an appropriate portion of the handgun 2F.

In various illustrative embodiments, the holster 100 body comprises at least a pair of opposed side walls comprising a first side wall 2K, and a second side wall 2J. Typically, the first side wall 2K is considered the outer side of the holster 100, and is worn away from the user's body, while the second side wall 2J, is considered the inner side of the holster 100, and is worn against or adjacent to the user's body.

The holster 100 body may further comprise a front wall 2D, and/or a rear wall 2M, having one or multiple spring loaded doors/flaps 2D connected to the front and/or rear of the holster. Optionally, the front wall 2D, and/or the rear wall 2M may comprise extended portions of the first side wall 2K, and/or the second side wall 2J.

It should also be appreciated that the holster 100 may be formed such that one or more of the first side wall 2K, the second side wall 2J, and/or the one or multiple spring loaded self-closing doors/flaps 2D, work as a wall mounted in the front and/or the rear 2M of the holster 100. The one or multiple spring-loaded self-closing doors/flaps 2D work as a wall, and will be sufficient to define the cavity 2H, for receiving the handgun 2F.

Alternatively, the walls of the holster 100 may be contoured or shaped to better accommodate a specific type or model of handgun 2F, or other item to be retained within the holster 100.

The body and other parts of the holster 100 may be formed of any appropriate durable material or combinations thereof for example, a polymeric material or a polymeric composite. Alternate materials of construction may include one or more of the following: leather, steel, aluminum, titanium, and/or other metals, as well as various alloys and composites thereof, glass-hardened polymers, polymer or fiber reinforced metals, carbon fiber or glass fiber composites, continuous fibers in combination with thermoset and thermoplastic resins, chopped glass or carbon fibers used for injection molding compounds, laminate glass or carbon fiber, epoxy laminates, woven glass fiber laminates, impregnate fibers, polyester resins, epoxy resins, phenolic resins, polyimide resins, cyanate resins, high-strength plastics, nylon, glass, or polymer fiber reinforced plastics, thermoform and/or thermoset sheet materials, or the like, and/or various combinations of the foregoing.

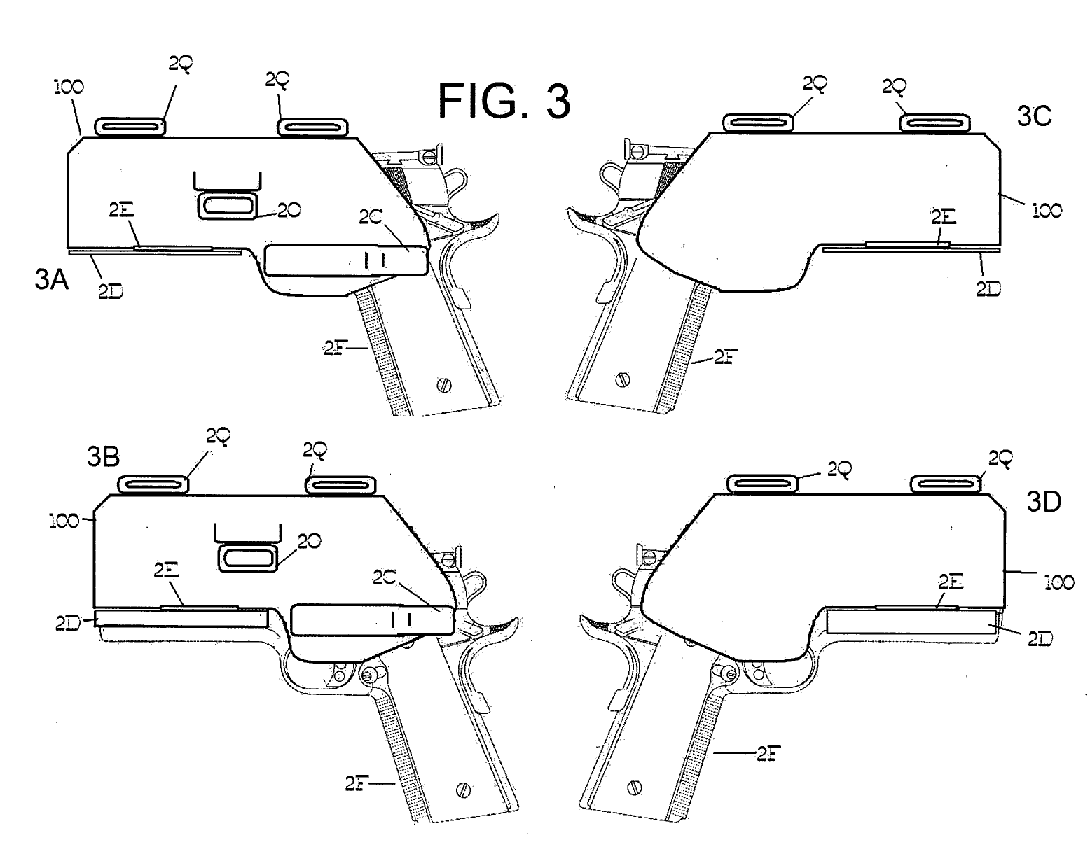

Referring to FIG. 1-10B, a fast draw security holster 100, is constructed in accordance with the present invention with a handgun 2F disposed therein. The fast draw security holster 100 includes a holster 100, body characterized as having an inner wall 2J, an outer wall 2K, a spring loaded self-closing front door/flap 2D, or open front, a rear wall 2M, and a closed or open bottom, which together cooperate to define a pocket/cavity 2H, (illustrated in FIG. 1) for holding the handgun 2F. The holster 100 body is typically molded or shaped so that the handgun 2F, fits snugly in the pocket/cavity 2H, formed by the walls, as illustrated in FIG. 1-10B. The walls further cooperate to define an open top portion and a bottom portion. The handgun 2F, is inserted into the holster 100 body through the open top portion such that a barrel of the handgun 2F, is disposed substantially adjacent to the bottom portion of the holster 100, body and the handle of the handgun 2F extends upwardly from the open top portion. With the handgun 2F disposed in the holster 100 body, a trigger guard of the gun abuts the rear wall 2M, near the open top portion of the holster 100 body. The holster 100 body is attachable to a belt, ankle, or leg holster via a belt passing through receiving slots/holes 2O, incorporated into the holster 100 body and belt receiving slots/holes 2O, formed in a backing plate 2P, as shown herein. The backing plate 2P is typically secured to the inner wall 2J, of the holster 100, with a plurality of screws passing through a plurality of holes 2L, in the holster 100, next to the thumb locking release lever/button 2C, as shown FIGS. 1C and 1D. For use in shoulder fitting, holster 100 of the present invention, has loops 2Q, attaching the holster 100, via body straps to secure the holster 100, to under the shoulder as shown in FIG. 3.

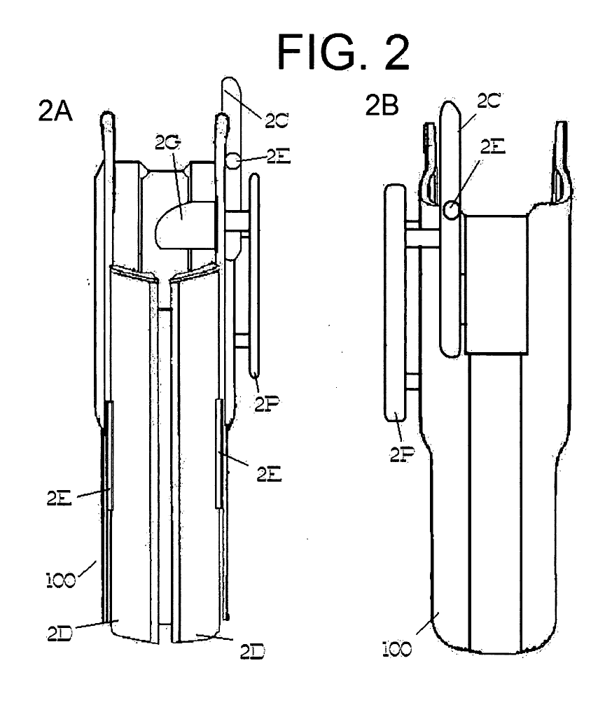

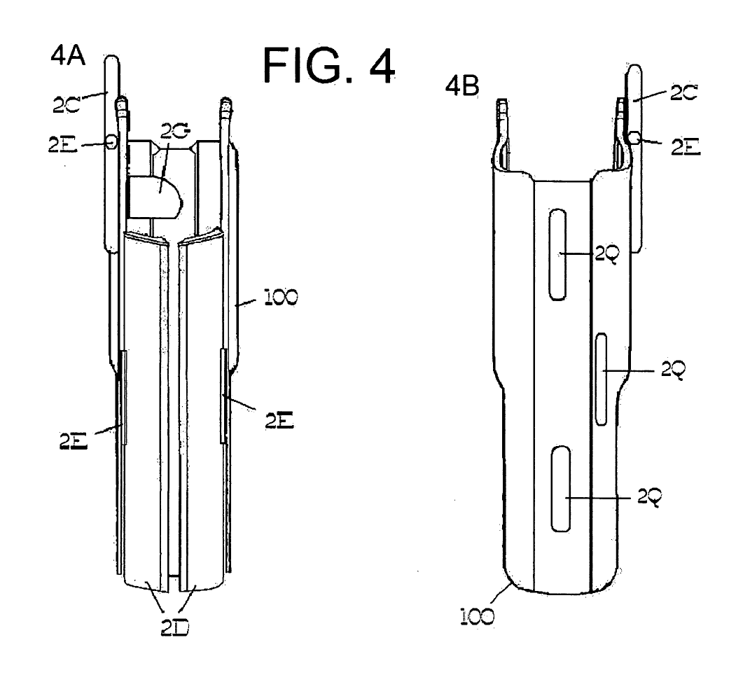

Holster 100 bodies as described above can be manufactured of various types of materials, and in shapes and sizes to accommodate different types of handguns 2F or other devices. FIG. 1-4B shows a right hand holster 100 of the present invention; FIG. 3-4B shows a right hand shoulder version of the holster 100. FIGS. 1A and 1B show right side views, 1C and 1D show left side views, 2A and 2B show front and back views, and 3A and 3B show right side views of shoulder holster 100. FIGS. 3C and 3D show right side views, while 1K and 1L show front and back views of a shoulder-fitted version of holster 100. Referring now to FIG. 1-4B, the fast draw security holster 100, of the present invention, is provided with a thumb engaging lever/button 2C, located on the inner side wall 2J, of the holster 100, between the wearer and the holster 100. Referring now to FIG. 2A and FIG. 4, in order to lock the handgun 2F, in the holster 100 body when the handgun 2F, is not in use, the thumb locking release lever/button 2C, includes one or multiple nibs 2G, of a projecting piece, part, or projection, of any appropriate size and shape, which is extendable through the trigger guard of the handgun 2F, so as to secure the handgun 2F in the cavity/pocket 2H, of the holster 100. Referring now to FIG. 1-10B, the fast draw security holster 100, of the present invention is provided with one or multiple spring loaded self-closing doors/flaps 2D, which at any length of the holster 100, allow closure to the handgun 2F in the cavity/pocket 2H of the holster 100.

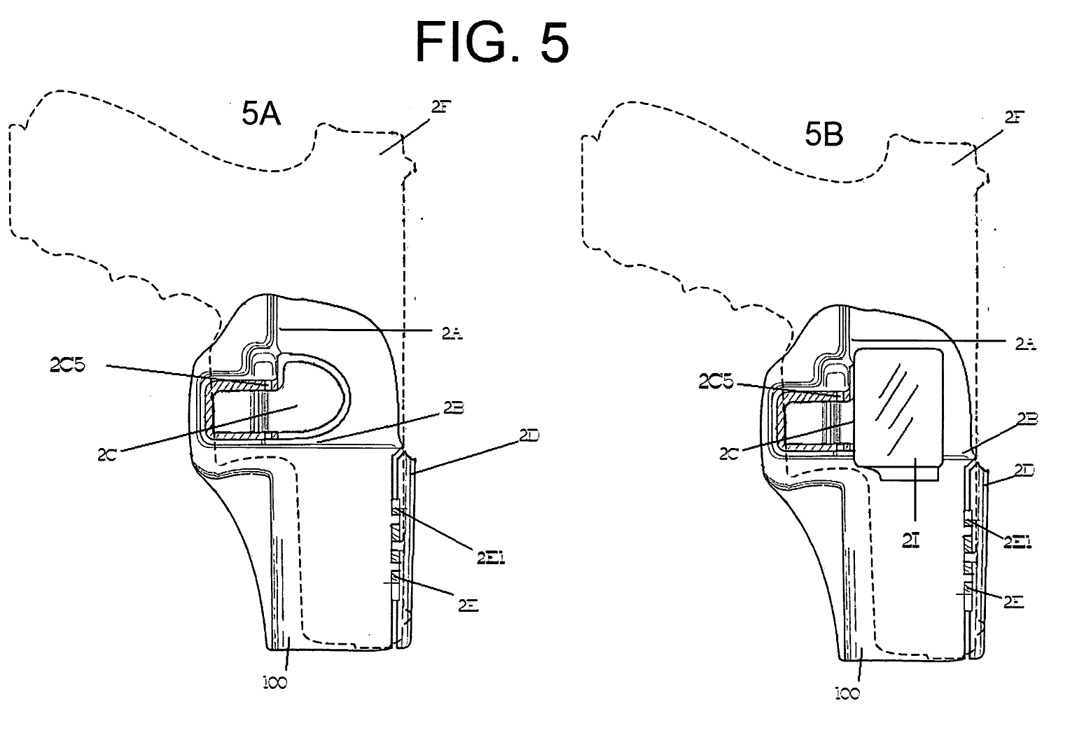

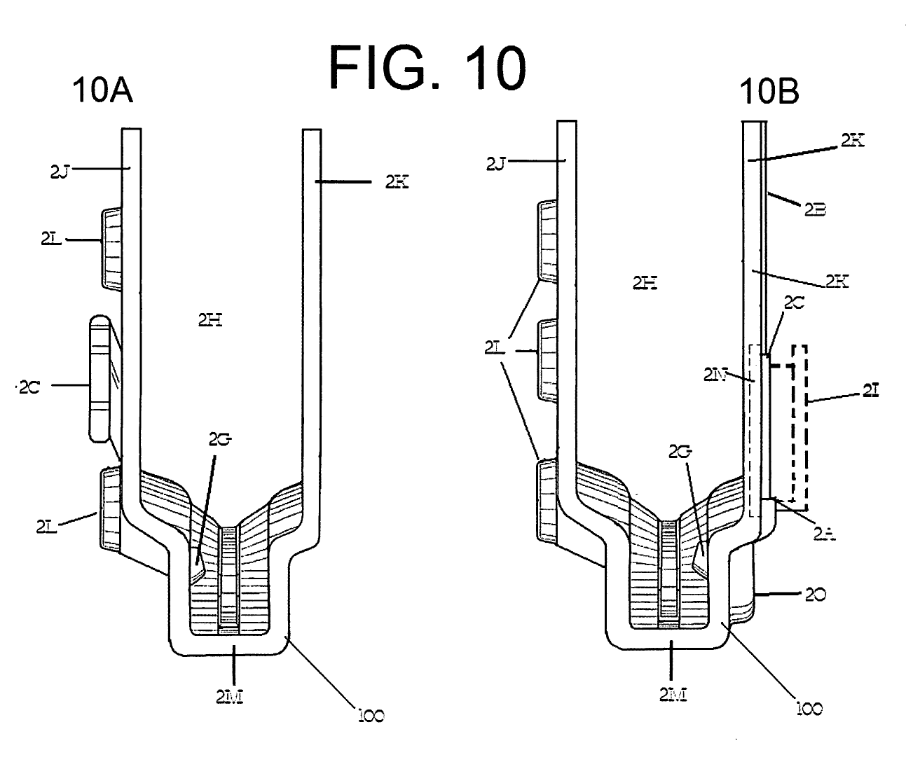

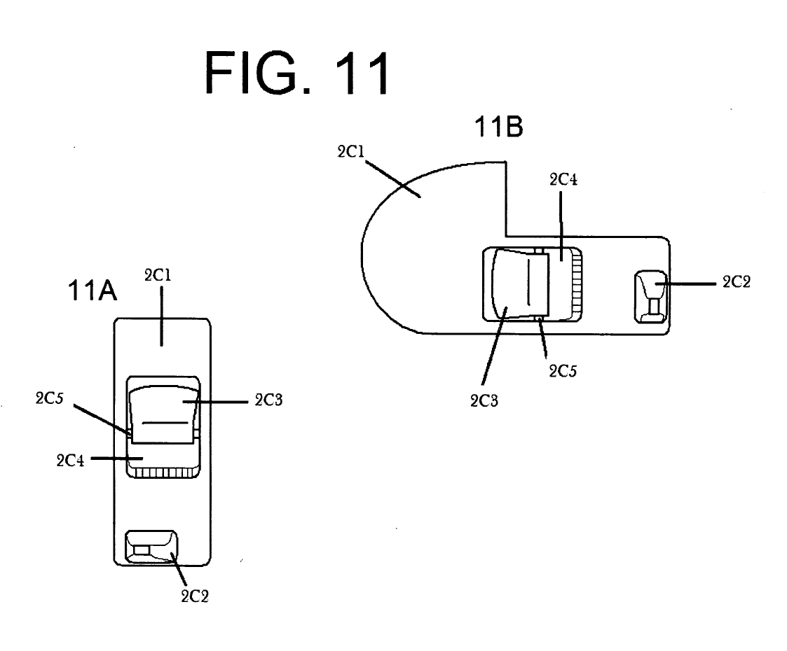

As illustrated most clearly in FIG. 1-10B, the holster 100, includes a finger/thumb engaging lever/button 2C, which is located on the outer side wall 2K, or the inner side wall 2J, which is connected to the holster 100, by means of having a pin/rod 2C5, in conjunction with a torsion spring 2C3, to allow the finger/thumb engaging lever/button 2C, to pivot/rotate in a manner to unlock the handgun 2F, from the holster 100, when engaged, and lock the handgun 2F, when it is inserted into the cavity/pocket 2H. The holster of the present invention also includes a finger guard/cover 21 as illustrated in FIG. 5B, 6, 8B, 9B and 10 B, which is constructed in a manner/method to enclose the finger engaging lever/button 2C, obstructing unauthorized observation of the action of engagement of the finger engaging lever/button 2C, which is located on the outer side wall adjacent to the spring loaded finger engaging lever/button 2C. The holster 100, illustrated in FIG. 1-10B also includes one or multiple spring loaded doors/flaps 2D, to allow the handgun 2F, to be enclosed in the holster 100, cavity/pocket 2H, and/or to be drawn in any direction away from the holster 100, and the user. The holster 100, of the present invention can comprise of an open “U” shape holster 100, body as illustrated in FIG. 10. The holster 100, body can be formed with a finger groove 2A, and a bottom finger guide 2B, on the outer side wall 2K, to allow the user's finger to be guided to the finger engaging lever/button 2C, to draw the handgun 2F, from the holster 100. The holster body 100 may also be formed with a groove 2N, to provide a clear area for the finger/thumb engaging lever/button 2C, to pivot on a pin/rod 2C5, and a torsion spring 2C3, when that lever/button is actuated to lock or unlock the handgun 2F.

1. A method of manufacturing a holster, comprising: a holster body with an open “U” shape and or having one or multiple spring loaded self-closing doors/flaps that extend across any appropriate portion of the front and/or rear of the holster, allowing enclosure of the handgun, wherein one or multiple spring loaded self-closing doors/flaps open upon forward, rearward, or other motion from the user after the thumb/finger engaging lever or button has been retracted by means of unlocking the handgun and closed after the gun has been drawn, returning back to its original holstering body state, wherein the shoulder and chest-fitted versions of the holster have an open “U” shape body or have one or multiple spring loaded self-closing flaps or doors connected to the holster underneath the barrel of the firearm and/or underneath the trigger guard to allow a downward and or backwards draw, wherein the spring loaded thumb/finger engaging lever or button is attached to the holster between the user and the holster on the inner side wall, where it would be mounted to the wearer and/or on the outer side of the holster where it can be engaged by the users finger, and wherein holster also includes a finger guard/cover which can be made of any appropriate material in any size or shape such that it encloses the finger engaging spring loaded lever/button, thereby obstructing observation of the action of engaging the finger engaging spring loaded lever/button.

2. The holster of claim 1, wherein the holster body is attachable as a belt, ankle and leg/thigh, or chest holster via a belt/strap passing through receiving holes or slots incorporated into the holster body.

3. The holster of claim 1, wherein the body and other parts of the holster may be formed of any appropriate durable material or combinations thereof, such as plastic, nylon, resins, metal and leather and formed into any type such as a duty belt holster, leg/thigh holster, ankle, chest and shoulder holsters comprising of a thumb/finger engaging lever/button located either on the inner side wall of the holster and/or on the outer side of the holster allowing secure locking and unlocking of the handgun/firearm or other device, and which is engaged by the users thumb or finger.

4. The holster of claim 1, wherein the holster body has an “L” shape groove on the outer side of the holster in which the finger can be guided in a direction towards the finger engaging lever and when engaged the user's finger can go in a forward motion.

5. The holster of claim 1, wherein the holster body comprises of an open “U” shape holster body and or have one or multiple spring loaded doors/flaps on the front and/or rear of the holster that would allow a handgun to be drawn in multiple directions from the user/holster.

6. The holster of claim 1, wherein the holster also includes a finger guard/cover which encloses the finger engaging lever/button, obstructing observation of the action of engaging the finger engaging lever/button.

7. The gun holster of claim 1, wherein the spring-loaded thumb/finger engaging lever or button has one or multiple nib members of any appropriate size or shape, which extends through the trigger guard of the gun when the gun is disposed in the pocket of the holster body.

8. The holster of claim 1, wherein the ankle, belt, thigh/leg or chest holster the front can be open by means of having a open “U” shape holster body or have one or multiple spring loaded self-closing flap or door members that extend any amount of portion of the holster which are mounted to the front or rear of the holster where the gun can be drawn in a forward or upward/downward direction.
